(19) United States
(12) Patent Application Publication
(10) Pub. No.: US 2009/0026077 A1
(43) Pub. Date: Jan. 29, 2009

(54) RAPID ELECTROCHEMICAL EVALUATION APPARATUS

(75) Inventor: Robert B. Dopp, Marietta, GA (US)

Correspondence Address: KNOBBE MARTENS OLSON & BEAR LLP, 2040 MAIN STREET, FOURTEENTH FLOOR, IRVINE, CA, 92614, US

(73) Assignee: QuantumSphere, Inc., Santa Ana, CA (US)

(21) Appl. No.: 11/829,843

(22) Filed: Jul. 27, 2007

(51) Int. Cl. G01N 27/333; G01N 27/28

(52) U.S. Cl. 204/415; 204/400

(57) ABSTRACT

A system and method are provided for rapidly evaluating electrochemical components such as catalysts, electrodes, electrolyte, and membranes that delivers a high degree of accuracy and requires minimal materials costs. In one embodiment, the system may comprise a detachable electrochemical cell for housing an electrochemical reaction. The cell may comprise an anode chamber and a cathode chamber separated by an ion-diffusion membrane and an electrically conductive current collector in electrochemical communication with the cell. The reaction cell includes an outlet port in the cell to permit the removal of product gasses, and ports to permit the flow of electrolyte through said cell. The system further comprises means, for example, a reciprocating piston, for sealing the reaction cell to the system to prevent exposure of the electrochemical reaction to the ambient environment, where the cell and adjacent components may be sealed by, for example, gaskets, that permit rapid separation.

### BACKGROUND OF THE INVENTION

1. Technical Field

This disclosure generally relates to a device for the quantitative evaluation of catalysts as well as other materials in electrochemical reactions. The device can be used to determine a variety of cell current, voltage, and resistance properties in electrochemical cells, and may be used for the rapid evaluation of many samples. More specifically, the device is useful in the evaluation of catalysts, separators, and electrolytes for electrolysis cells and fuel cells.

2. Related Art

Quantitative evaluation of electrolysis and fuel cell catalysts, electrodes, membranes, and separators is often time consuming, cumbersome, and requires larger amounts of testing material, as the user must evaluate these materials in a finished device to get an accurate depiction of electrochemical performance and efficiency. Ideally, electrochemical evaluation should be rapid, present accurate data detailing both individual components as well as their synergistic relationship, and require a minimal amount of electrode materials and liquid or solid electrolyte. In current electrochemical evaluation techniques, the user must test these materials in complete devices requiring additional time to prepare and costly materials, or relegate to a test apparatus which may not give detailed information about all of the operating parameters.

Another significant limitation of electrochemical evaluation equipment is the inflexibility to accommodate modifications to cell design. A typical solution to this problem is to build the device in a very robust frame and use carefully aligned linear bearings to drive the components exactly along some desired axis. This typically requires a larger-scale unit and extended change-over time when new cells are designed.

### SUMMARY OF THE INVENTION

In one embodiment of the present invention, a system is provided for the rapid evaluation of electrolysis reactions, where the system may comprise a detachable electrochemical cell for housing an electrochemical reaction. The cell may comprise an anode chamber and a cathode chamber separated by an ion-diffusion membrane and an electrically conductive current collector in electrochemical communication with the cell. A plurality of contacts is preferably provided to serve as either working, counter, and/or reference electrode contacts.

The reaction cell includes an outlet port in the cell to permit the removal of product gasses, and ports to permit the flow of electrolyte through said cell. The invention, as exemplified in the embodiments disclosed herein, permits the rapid release of the detachable electrochemical cell from the system to permit interchangeability of one or more electrochemical components used in creating electrolysis reactions, including electrodes in the form of plates or other shapes and configurations.

The system further comprises a means for sealing the reaction cell to the system to prevent exposure of the electrochemical reaction to the ambient environment, where the cell and adjacent components may be sealed by, for example, gaskets, that permit rapid separation. One sealing means contemplated includes a reciprocating piston driven by one of a number of possible drives, including hydraulic or pneumatic pressure. Other means are contemplated that provide for the rapid removal of the reaction cell. In one embodiment, the present invention may be embodied by a system that permits the evaluation of half-cell electrochemical reactions. In such an example system, a counter cell is provided to effectuate the other half of the reaction.

### BRIEF DESCRIPTION OF THE DRAWINGS

FIG. 1 is a cross sectional view of the reaction cell test stand.

FIG. 2 is a lateral section of the reaction cell test stand.

FIG. 3 is a cross section of reaction cell.

FIG. 4 lateral section of the reaction cell.

FIG. 5 illustrates other necessary components of the reaction cell.

FIG. 6 is a photograph of the assembled reaction cell and test stand configured for “half-cell” testing.

FIG. 7 illustrates the assembly of the reaction cell.

FIG. 8 gives an example of components for use in “full-cell” testing.

FIGS. 9A and 9B illustrate an electrolytic full-cell assembly.

FIG. 10 is an example of the assembled device operating with a multitude of reaction cells.

FIGS. 11a and 11b illustrate an electrolytic half-cell assembly.

FIG. 12 is a photograph of the use of a fluidized bed reactor cell and test stand in vertical orientation.

FIG. 13 is an example of a half-cell experiment

FIG. 14 is an example of a full cell experiment.

### DETAILED DESCRIPTION OF SOME PREFERRED EMBODIMENTS

In a preferred embodiment, the present invention comprises an apparatus that comprises a test stand and a reaction cell configured such that the cell substantially accurately depicts electrochemical performance of a larger, complete system. The reactor cell may be configured to operate as a “half-cell” wherein one electrode is evaluated, as a “full-cell” wherein two electrodes are evaluated, as a “reactor cell stack” wherein a multitude of individual cells are tested at once, or as a fluidized bed reactor. Such an apparatus allows for easy assembly of various test apparatuses for the study of hydrogen generation via water electrolysis. Being built on a robust test stand, test fixtures can be added and altered at will. This flexibility allows for the evaluation of one or more electrochemical cell expediently with minimized cost. A variety of electrochemical systems may be tested using one or more embodiments of the present invention, including, but not limited to, water electrolyzers and fuel cells. Devices that are configured to electrochemically convert reactants into products when energy is applied are generally known as electrolyzers. For an electrolyzer to operate with high efficiency, the amount of product produced during reaction should be maximized relative to the amount of energy input. In many conventional devices, low catalyst utilization in the electrodes, cell resistance, inefficient movement of electrolyte, and inefficient collection of reaction products from the electrolyte stream contribute to significant efficiency loss. In general, water electrolysis technology needs considerable improvements in catalysts, electrodes, electrolytes, separators, and architecture to become of practical use in terms of both efficiency and hydrogen output. The device described in the preferred embodiments eliminates the issues associated with designing and constructing a complete electrolyzer apparatus, namely time intensity and cost of materials. Likewise, a fuel cell is a device that converts chemicals directly into electrical energy, with similar associated catalyst, electrode, electrolyte, and design issues. Most preferably, the device described in the preferred embodiments will eliminate the need to build complete electrochemical systems to save time and money, and is highly useful for rapidly evaluating both new materials and overall cell design changes. In addition, the device is useful for testing a wide array of reaction cell configurations, as the test stand may be oriented horizontally, vertically, or angles in between.

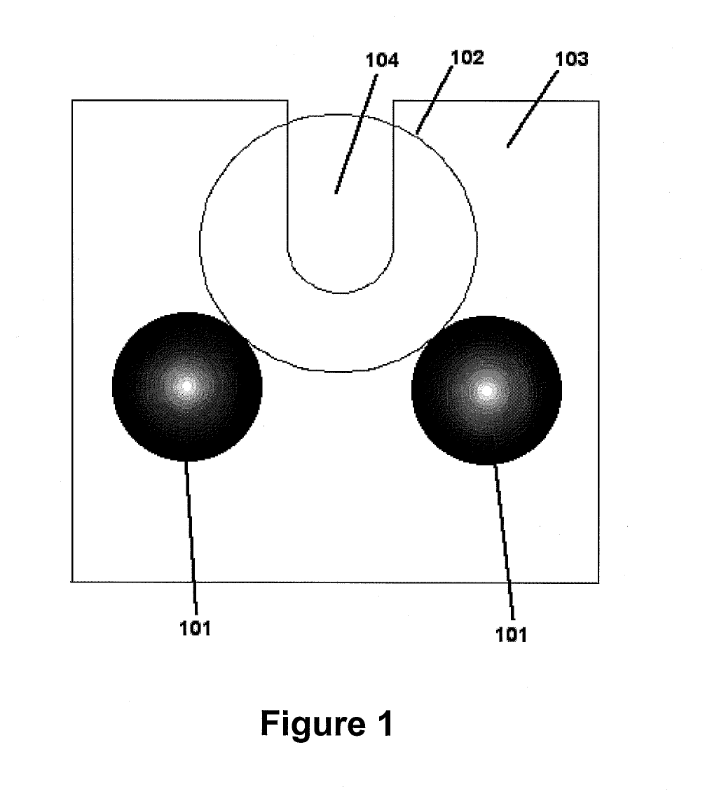

Referring to FIG. 1, a cross-sectional diagram of one embodiment of the invention may be described. In such an embodiment, by way of example, the system comprises a test stand. Support rods 101 are about 45 degrees from the vertical, or 90 degrees from each other relative to the center of reference circle 102. They are made of a non-corrosive material such as stainless steel. Preferably, rods 101 are at least 2.54 cm above the bottom edge of back support plate 103 to allow tubes to pass under them. The view is through the back support plate 103 and show cutout 104, intended for the counter electrode (not shown).

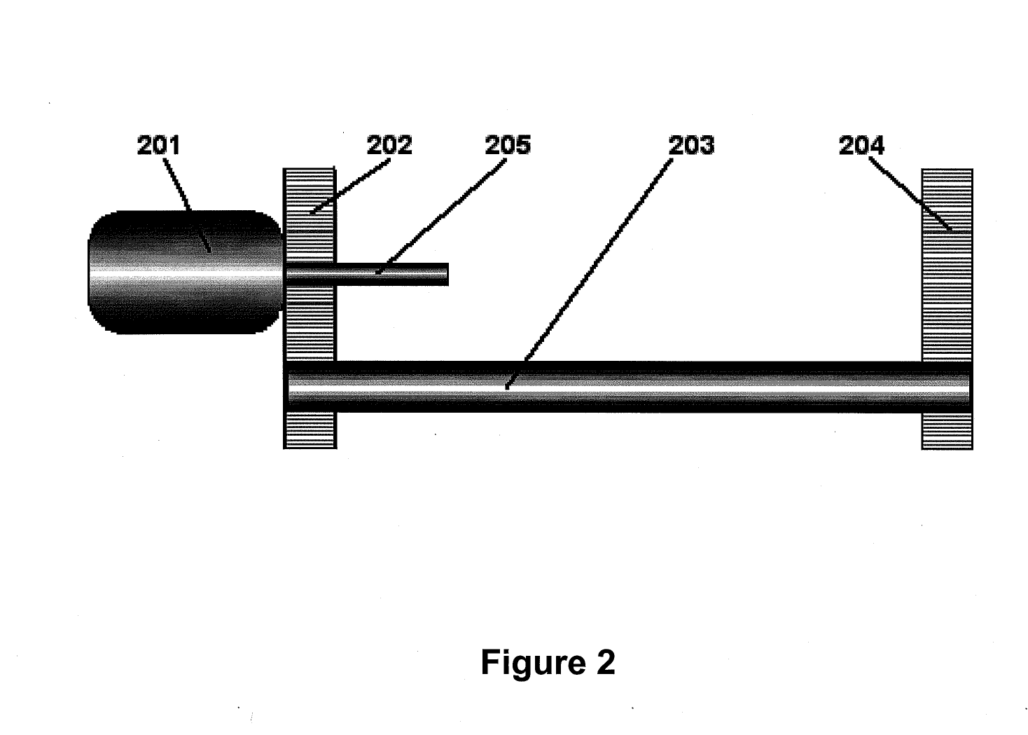

A side-on view of the test stand is illustrated in FIG. 2. The reaction cell to be evaluated is compressed and held together by air cylinder 201, which passes through front end plate 202 and holds support rods 203, which are exactly parallel to the line of force from the air cylinder. The reach of the push rod 205 is dependent on the size of the reaction cell to be evaluated. The support rods are held on the right side by the back support plate 204 which is exactly parallel to the front end plate. The length of the support rods is a convenient length to holding test apparatuses. All materials must be non corrosive such as stainless steel.

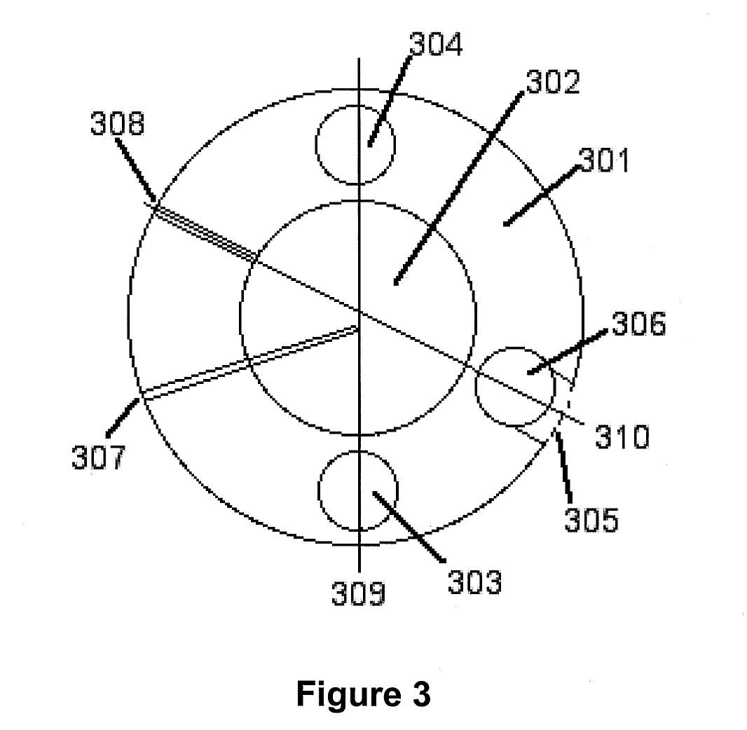

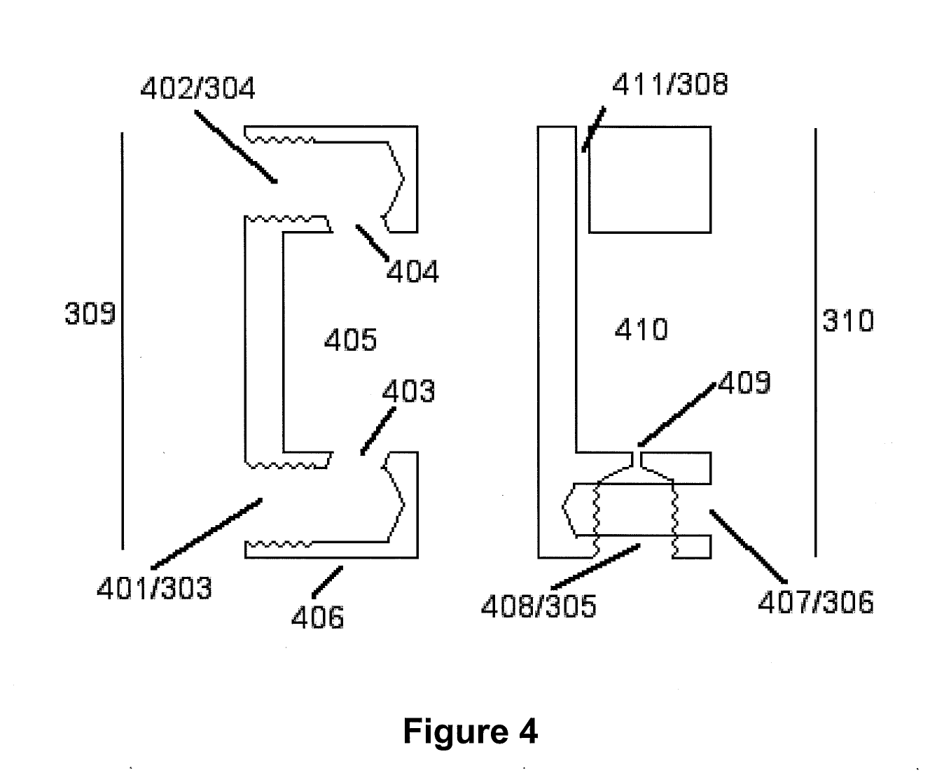

An example of a reaction cell configured for the evaluation of water electrolysis “half-cell” reactions is illustrated in FIG. 3. The body of the electrolysis apparatus 301 is made from a non-conductive, non-corrosive material such as PVC, Acrylic or Nylon. This view is a cross section through the middle of the body showing central space 302 to hold the test electrode. Electrolyte inlet 303 and outlet 304 are also both visible. Port 305 to hold the reference electrode is coming into circular body 301 below horizontal to discourage bubble trapping. Hole 306 intended to hold a cellulosic fibrous material such as cotton as a bubble trap to prevent interference with the reference electrode. There are also two small holes 307 and 308 which carry the contact wires to the working electrode. Hole 308 reaches to the center of chamber 302 and the other 307 reaches only to the edge of the chamber. A coiled conductive wire, preferably nickel or gold, has each end leading out these ports. After fitting the contact coil in place, holes 307 and 308 are back-filled with epoxy adhesive to seal them from leakage. Referring to FIG. 4, a lateral view of the same reaction cell from FIG. 3 is shown. The two views are through-cut across reference lines in FIG. 3 at 309 and 310. The 309 cut shows the electrolyte entry port 401 and exit port 402. Also shown is the entry 403 and exit 404 ports within the test chamber. The depth 405 and thickness 406 are also illustrated.

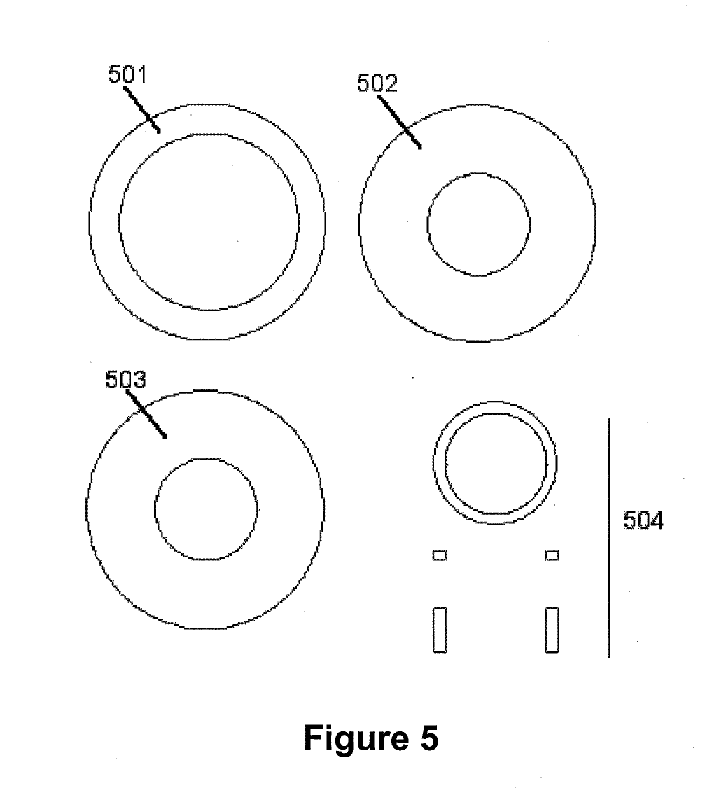

The reaction cell has several other components. Referring to FIG. 5, there are four different components of the working electrode body and associated parts. Gaskets 501 and 502 are preferably a Teflon®-based material. Compression ring 503 is made from a thick, non-conductive, non-corrosive material such as PVC, Acrylic or Nylon. Part 504 is a critical component which holds the test electrode (not shown) firmly against the coiled spring current collector (also not shown). The height in this example is 7.75 mm (0.305″) but can be made to whatever height is appropriate to hold electrodes of differing thicknesses firmly against the current collector. The outside diameter is 19.05 mm (¾″) and id is 15.88 mm (⅝″). The two holes running through the center of the part is about 5.59 mm (0.22″) and should be as close as practical to one edge of the cylinder. It is made from some non-conductive, non-corrosive material such as PVC, Acrylic or Nylon. This component 504 is important because it is serving more than one function within the device. It physically holds the test electrode firmly against the contact wire while also directing flowing electrolyte across that electrode. It's height is needs to be long enough to have good compression while not so much as to bend, break or compress the electrode. To that end, several are made and the proper individual is selected according to the physical makeup of the test electrode.

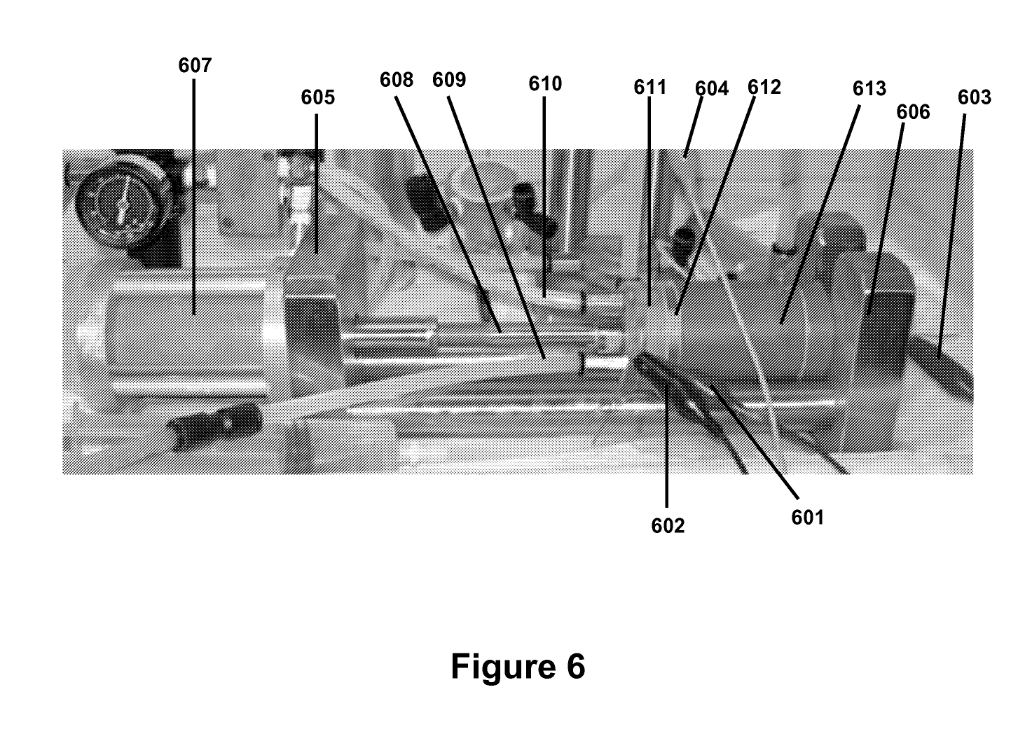

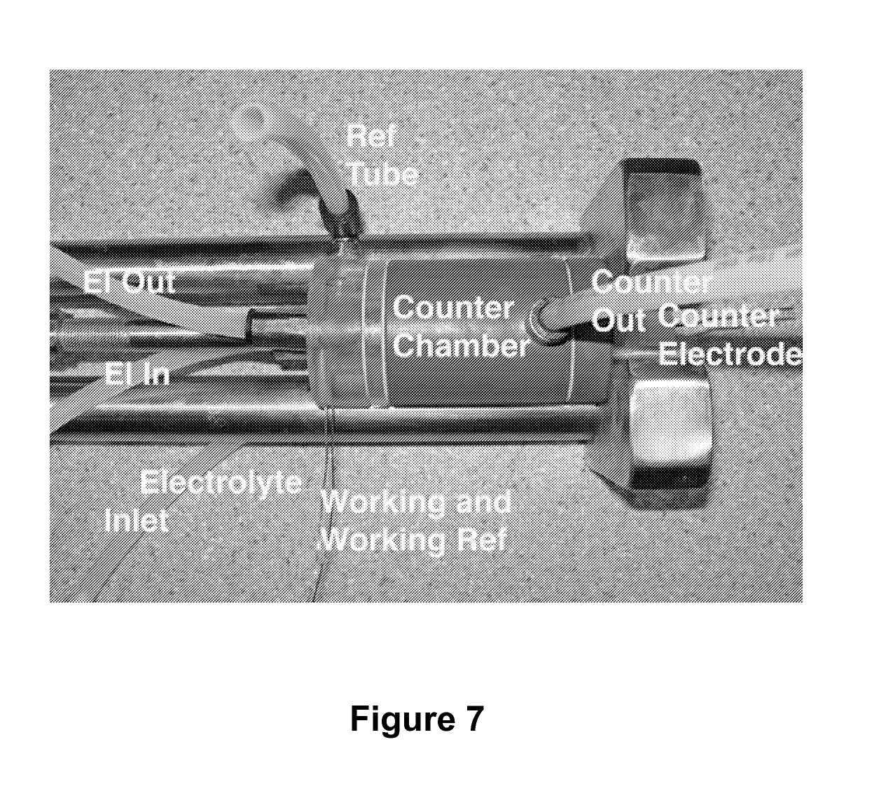

Referring to FIG. 6, a photograph of the reaction cell and test stand is shown, including working electrode 601, working reference electrode 602, counter electrode 603 and reference electrode 604. Also shown are several of the above mentioned components such as front end plate 605, back support plate 606, air cylinder 607, push rod 608, and inlet and outlet tubes 609 and 610. The working electrode resides inside body 611 and is held in place by compression ring 612 and counter body 613, which holds a platinum screen counter electrode. A fully assembled device is shown in FIG. 7.

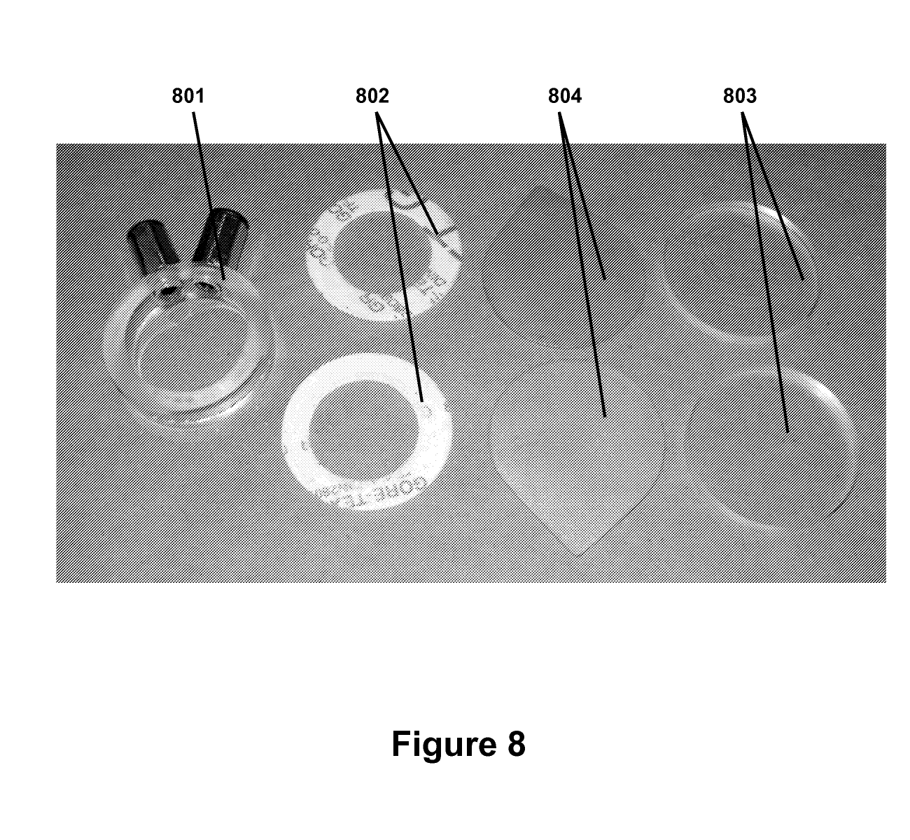

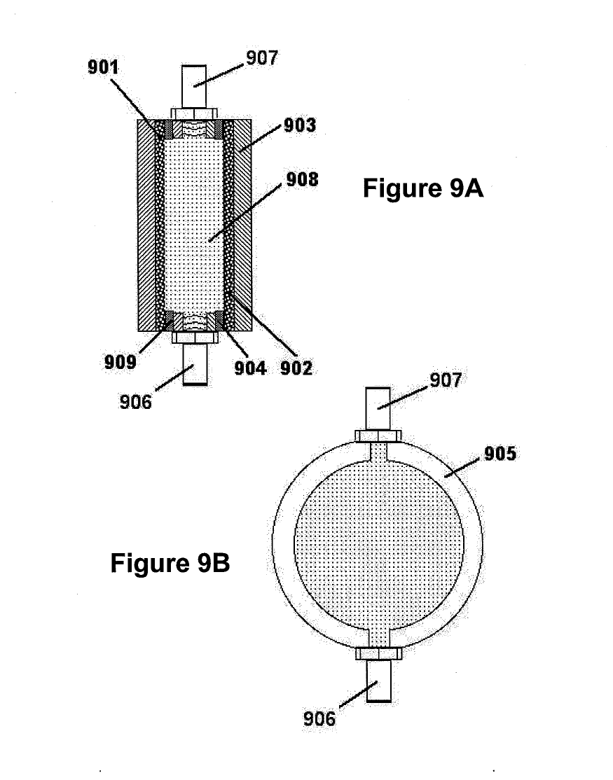

FIG. 8 illustrates the device components which may be used to run “full-cell” testing. Central chamber 801 is shows two ports, but usually there is a third located opposite to one of the two shown. It is composed of non-corrosive material such as PVC, Acrylic or Nylon. Gaskets 802 are needed which are typically made of a Teflon®-based material. Disk 803 has a diameter disk made from a non-conductive, non-corrosive material such as PVC, Acrylic or Nylon. Working electrodes 804 may or may not be of the same electrochemically active materials, but must be thick enough to maintain flat surfaces. FIG. 9 illustrates a fully constructed “full-cell” testing device.

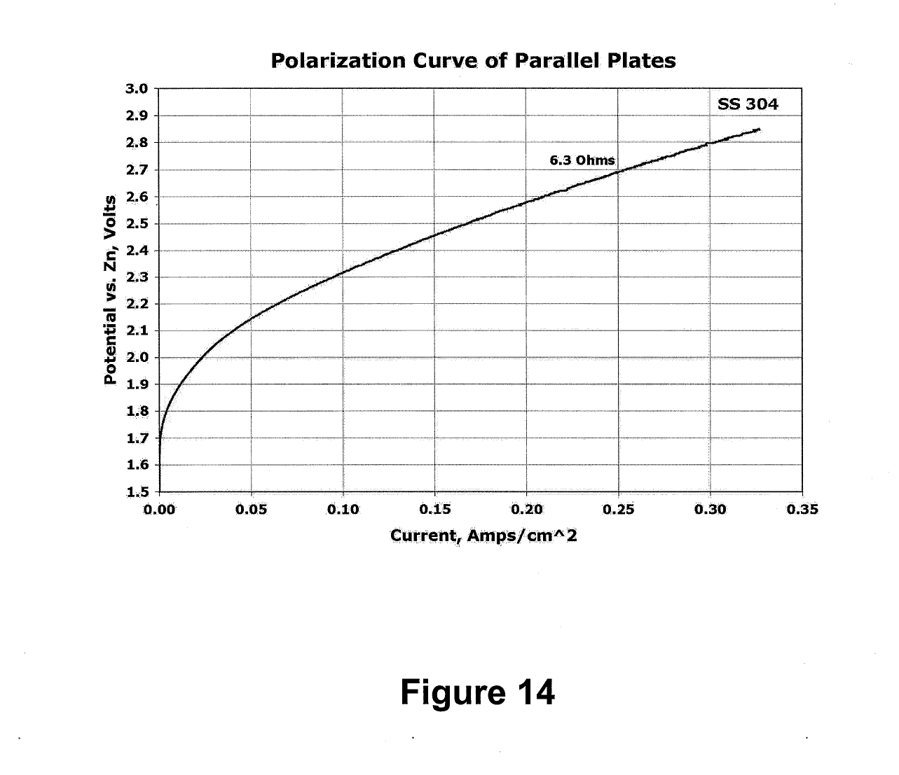

Referring to FIGS. 9A and 9B, a typical full cell experiment is described below. The electrode 901 is constructed using a separate engineering effort not described in this document. It may be a solid disk of metal, a solid disk treated in some way, a porous pellet or other forms. The only criterion is that the electrode be conductive, stable in the electrolyte and fit in the apparatus. In the example shown, a diameter of 5.08 cm (2″) is used with a thickness of about 1 to 2 mm (0.0625″). The electrode 902 is situated against a backing plate 903. A silicon grease coated Teflon® gasket 904 is situated next. The central body 905 is then placed on the parallel rails of the assembly apparatus. Next, another Teflon® gasket and second electrode 901 is placed. The two electrodes may or may not be of the same design and composition depending upon the experimental design. In this example, no separator is used producing a mixture of two moles of hydrogen for each mole of oxygen. This gas mixture is sometimes called “HHO”, “Water-Gas”, “OxyHydrogn” or “Brown's Gas” among others. All gaskets are lightly coated with silicon grease or a functional equivalent. The working electrode and working reference connector are attached to one of the two electrode plates 904 and the counter electrode and reference electrodes are both connected to the other electrode plate 901. A potentiostat and impedance spectrometer is used to control the experiment sometimes scanning from open circuit voltage to some predetermined potential while recording the current. The center body 905 is filled with electrolyte from inlet/outlet port 906 until there is a head of several inches above the outlet port 907. Other experiments may be galvanostatic where some current is established and voltage stability is recorded. This device is useful to demonstrate higher production rates using formulas developed in the smaller half-cell format. Also longevity tests and parameter studies are convenient on this apparatus. If two central bodies 905 are used, a separator can be inserted between them for full cell work using separate cathodic (electron consuming, hydrogen producing) and anodic (electron liberating, oxygen producing) chambers. The number of other experimental designs is as varied as the imagination of the experimenter. An example of the resulting data is shown in FIG. 14.

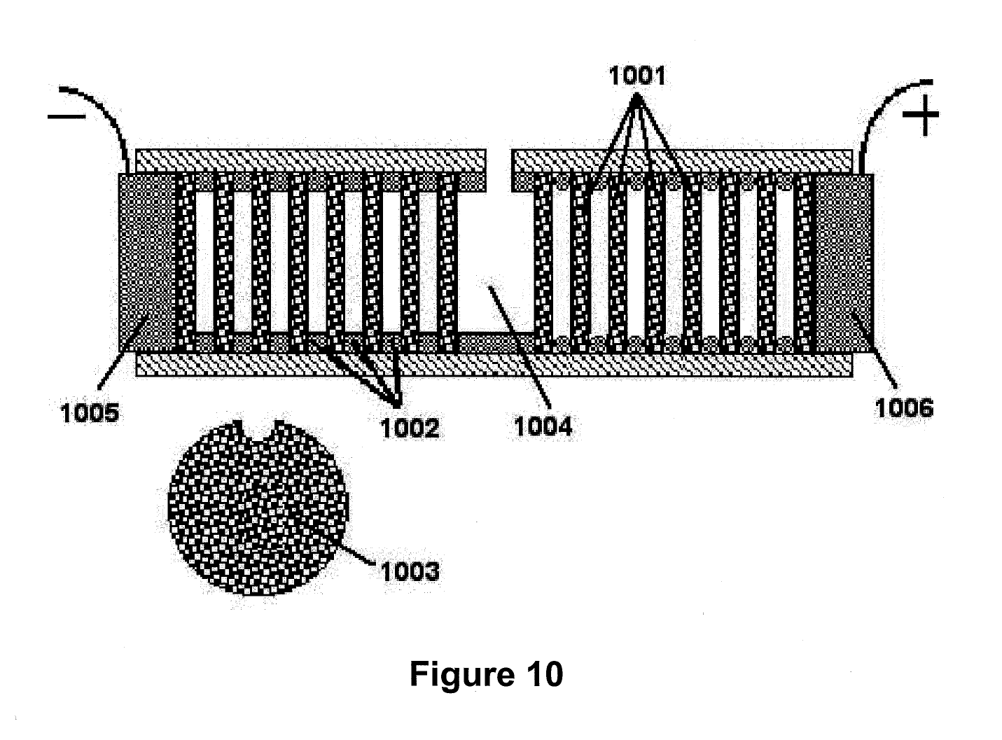

Referring to FIG. 10, “full-cell” testing device can be configured to test many electrodes at once in a reactor cell stack. It consists of a multitude of electrodes 1001 all isolated one from the other by insulating washers 1002. It is shown with flat washers on the left, and “O” rings on the right sets of electrodes. Each individual electrode 1003 has a notch in it to allow the combined hydrogen and oxygen to migrate to central segment 1004. The electrons are supplied at cathodic contact slug 1005 and withdrawn at contact slug 1006. All parts are contained in a non-corrosive, insulating sleeve which has an inside diameter just larger than electrode disks 1003.

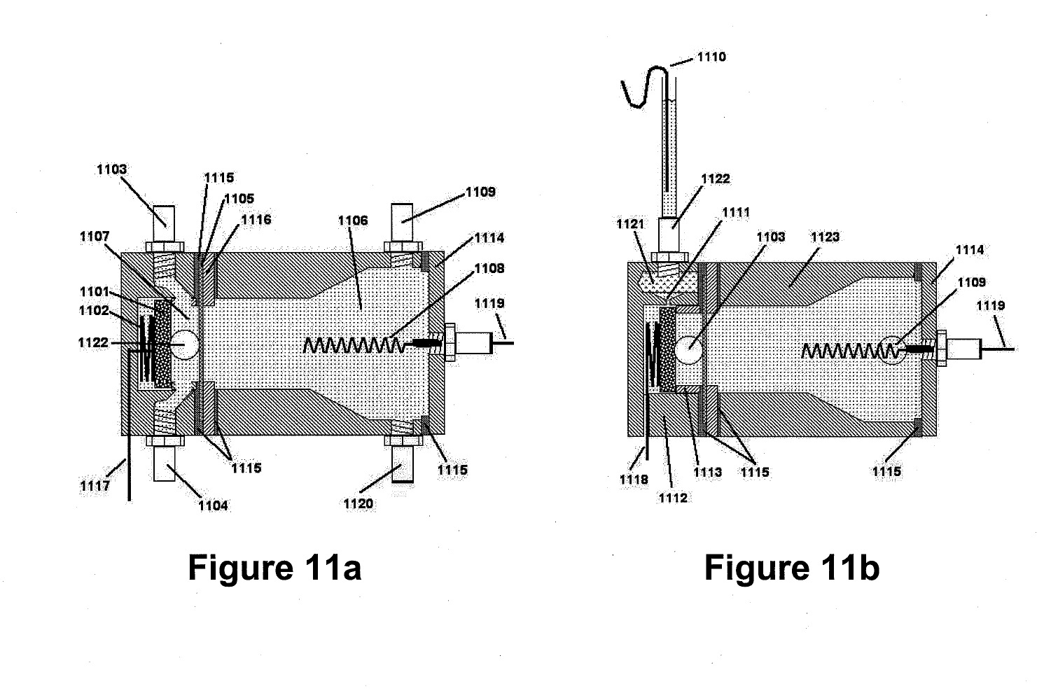

Referring to FIGS. 11a (side view) and 11b (top view); of the electrolysis cell in half-cell mode. The apparatus is filled with the electrolyte of choice. For water electrolysis experiments, this is typically potassium hydroxide, sodium hydroxide or a mixture of the two near the eutectic concentration. Other minor additives may be used such as surface tension modifiers and debubblers. For a cathodic experiment, electrons are applied to the working electrode 1101 via electrical contact 1102, where hydrogen is produced on the working electrode 1101 by the following general reaction: 2H₂O+2e⁻→2OH⁻+H₂. Hydrogen bubbles are swept from the reaction site through port 1103 in a pumped stream of electrolyte. The gas is separated in a device not shown as there are many ways removed gasses from liquid electrolyte. The bubble-free electrolyte flows into the chamber via an inlet port 1104 at a flow rate appropriate to sweep all bubbles. The counter chamber 1106 within the counter body 1123 is filled through inlet/drain port 1120. The hydroxyl ions migrate across a separator 1105 into the counter chamber 1106 as water migrates through the same separator into the working electrode chamber 1107. At the counter electrode 1108, oxygen is generated by the general reaction: 2OH⁻→H₂O+½O₂+2e⁻. The oxygen gas escapes thorough exit port 1109 by buoyancy. Additionally, a reference electrode 1110 is placed in ionic contact with the working electrode 1101 via an ion bridge, 1111. Stray bubbles are trapped in a fibrous cellulosic bubble trap 1121. The bubble free ion-bridge passes through the reference port 1122. Typically a zinc wire serves as the reference electrode but many other references can be chosen. While running this apparatus, the voltage between the reference and working electrodes is monitored as the current being drawn from the counter electrode is monitored.

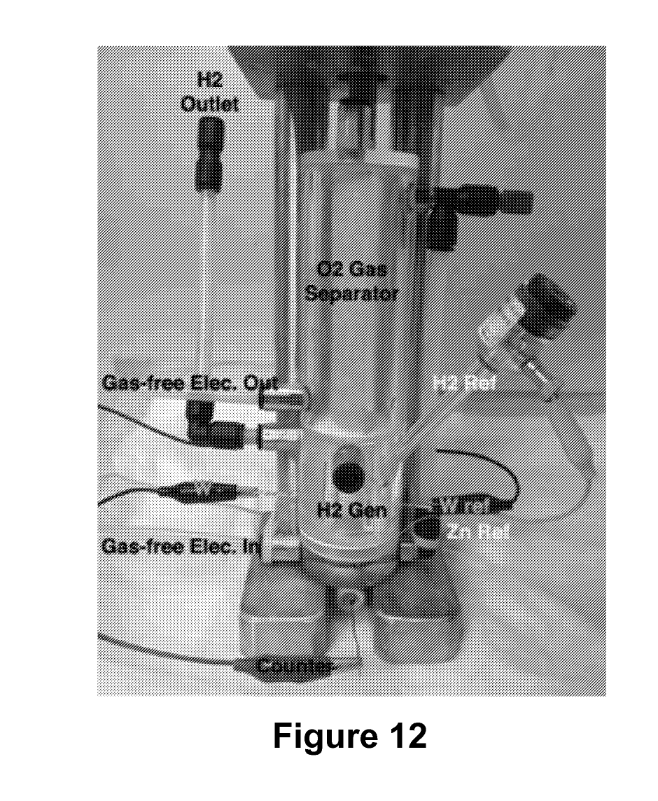

FIG. 12 shows an assembled fluidized bed reactor electrolysis apparatus assembled in the test stand in a vertical orientation. This allows for increased flexibility in reactor cell or cell stack designs. In the preferred embodiments, the test stand and reactor cell may be oriented in any direction.

The above description discloses several methods and materials of the present invention. This invention is susceptible to modifications in dimensions, methods and materials, as well as alterations in the fabrication methods and equipment. Such modifications will become apparent to those skilled in the art from a consideration of this disclosure or practice of the invention disclosed herein. Consequently, it is not intended that this invention be limited to the specific embodiments disclosed herein, but that it cover all modifications and alternatives coming within the true scope and spirit of the invention as embodied in the attached claims.

### EXAMPLE 1

### Half-Cell Evaluation

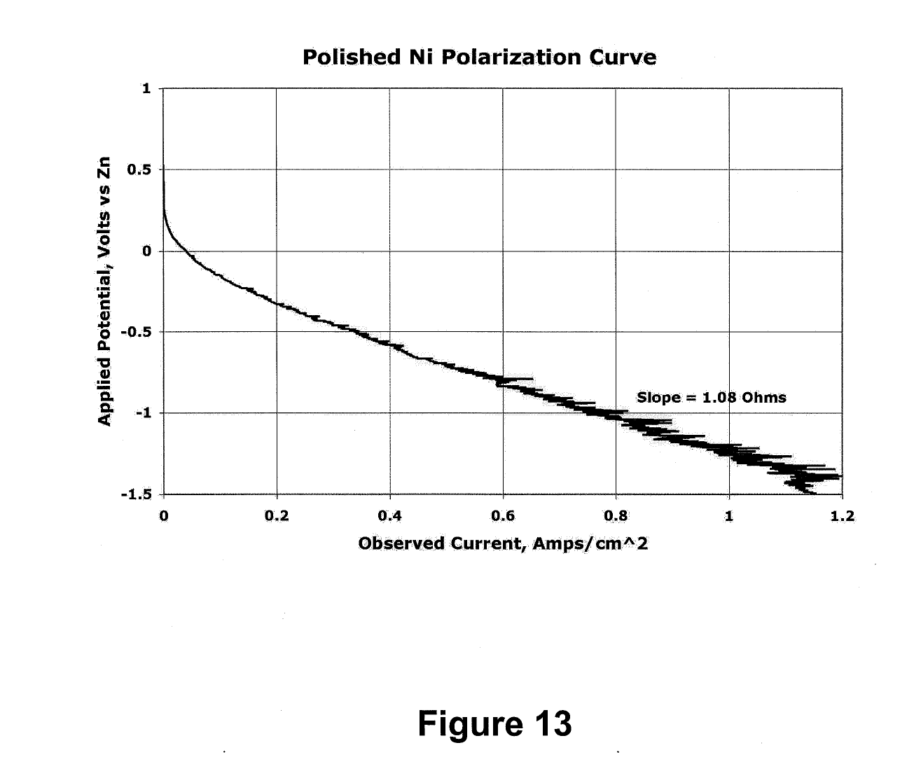

Referring to FIGS. 11a and 11b, a typical half-cell experiment is described below. The electrode 1101 is constructed using a separate engineering effort not described in this document. It may be a solid disk of metal, a solid disk treated in some way, a porous pellet or other forms. The only criterion is that the electrode be conductive, stable in the electrolyte and fit in the apparatus. In the example shown, a diameter of 19.05 mm (¾″) is used with a thickness of about 1 to 2 mm. The electrode is loaded into the holder 1112 and the electrode holder 1113 is placed in to hold electrode firmly against the spring-loaded current collector 1102. The separator 1105 is cut to about 1.6 cm (1.25″) typically using a hand punch. All gaskets 1115 and support disk 1116 are lightly coated with silicon grease or functional equivalent and assembled from the counter electrode end plate 1114 toward the working electrode in the order illustrated in FIG. 11a. The working electrode is attached to one of the two current collector leads 1117 and the working reference connector to the other current collector wire 1118. The counter electrode is connected to the counter electrode lead 1119. Finally, the reference lead is connected to whatever is used as a reference electrode 1110. A potentiostat and impedance spectrometer is used to control the experiment sometimes scanning from open circuit voltage to some predetermined potential while recording the current. Other experiments may be galvanostatic where some current is established and voltage stability is recorded. It is also possible to run impedance spectrums to perform impedance response analysis. The number of other experimental designs is as varied as the imagination of the experimenter. This device is very useful to run factorial experiments in which many catalyst formulations are examined for their effect on water electrolysis. An example of the resulting data is shown in FIG. 13.

### EXAMPLE 2

### Full-Cell Evaluation

Referring to FIGS. 9A (side view) and 9B (cross-section), “full-cell Tester” device is described. Two electrodes 901 and 902 face each other across an electrolyte pool 908. The two are separated by a center body 905 and gasketed by Teflon® rings 904 and 909. The body is filled with electrolyte of choice via inlet/output port 906. The support disks and center body are all 5.08 cm (2″) in diameter to fit on the parallel supports 101. In this configuration, no separator is used and gasses generated in the central chamber and exit together through exit port 907 by buoyancy. If two central bodies 905 are used, a separator can be inserted between them for full cell work using separate the cathodic and anodic chambers.

This device also lends itself to the study of multiple plate electrolyzers either with several of the center bodies 12 nn or a series of insulating gaskets (not shown). On can then stack as many series cells one wishes to characterize.

Other embodiments and arrangements are contemplated that provide for one or more of the advantages set forth herein. The description provided herein is by example only and not intended as a limitation upon the scope of the present invention.

What is claimed is:

1. A system for the evaluation of electrochemical reactions, the system comprising:
a detachable reaction cell for housing an electrochemical reaction;
an electrically conductive current collector in electrochemical communication with the cell;
a plurality of contacts serving as either working, counter, and/or reference electrode contacts;
an outlet port in said cell to permit the removal of product gasses; and
a plurality of ports to permit the flow of electrolyte through said cell, wherein the system is configured to permit the rapid release of the detachable electrochemical cell from the system to permit interchangeability of one or more electrochemical components used in creating electrolysis reactions.

2. The system of claim 1, wherein the reaction cell comprises an anode chamber and a cathode chamber separated by an ion-diffusion membrane;

3. The system of claim 1, further comprising gaskets to enhance the seal of the cell with the system.

4. The system of claim 1, wherein the system is configured to evaluate half-cell electrochemical reactions.

5. The system of claim 1, further comprising a counter cell to permit evaluation of half-cell electrochemical reactions.

6. The system of claim 1 further comprising a reciprocating piston to sealably engage the cell to the system to seal the electrolysis reaction from the ambient environment.

7. The system of claim 1 further comprising one or more support rails to support system components.

8. A compact electrochemical device suitable for the rapid evaluation of at least one electrochemical or catalytic reaction, the device comprising:
a reaction cell permitting the incorporation of electrolyte and two or more electrodes, and;
a test stand configured to compress and seal the reaction cell via a pneumatic piston.

9. The electrochemical device of claim 8, wherein the device is configured to that it may be oriented horizontally, vertically, or angled therebetween during effective operation.

10. The electrochemical device of claim 8, further comprising electrically conductive current collectors in proximity to the cell.

11. The electrochemical device of claim 8, further comprising a membrane for the separation of reaction products.

12. The electrochemical device of claim 8, wherein the device is configured to evaluate solid porous metal/metal oxide electrodes.

13. The electrochemical device of claim 8, wherein the device is configured to evaluate electrochemical fluidized bed reactions.

14. The electrochemical device of claim 8, further comprising a collector to permit collection of solid, liquid, or gaseous reaction products.

15. The electrochemical device of claim 8, wherein the reaction cell is configured to test reaction cell stack.

16. The electrochemical device of claim 8, wherein the reaction cell is configured to evaluate electrolysis reactions.

17. The electrochemical device of claim 8, wherein the reaction cell is configured to evaluate fuel cell reactions.
